(19) United States
(12) Patent Application Publication
(10) Pub. No.: US 2009/0110890 A1
(43) Pub. Date: Apr. 30, 2009

(54) Color changing wear indicator

(75) Inventors: Nohemi Garza, San Luis Potosi (MX); Lou D. Hibbard, Eagan, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/980,004

(22) Filed: Oct. 30, 2007

(51) Int. Cl. B32B 7/02; B05D 1/36

(52) U.S. Cl. 428/212; 427/402

(57) ABSTRACT

A substrate with a color changing indicator to identify wear of the substrate is disclosed. The color changing indicator generally comprises a substrate having a working surface with a first color and a surface coating comprising a second color, different than the first color, dispersed in a binder. The surface coating covers the first color of the substrate and repeated use of the article wears away the surface coating causing exposure of the first color to indicate wearing of the substrate. Also disclosed, is a method of making an article including a color changing indicator.

### FIELD

The present disclosure relates to a color changing wear indicator. In particular, the present disclosure relates to a substrate comprising a color changing wear indicator to indicate wear of the substrate.

### BACKGROUND

Cleaning articles may be disposable or reusable. Generally, a disposable item is used for one cleaning application and discarded. For example, paper towel is a disposable item that after used to wipe is discarded. A reusable item may be used repeatedly for several cleaning applications. Some cleaning articles, such as a broom, are reusable and can be used for a long period of time. Some cleaning articles, such as a sponge, are reusable, but are used for a shorter period of time and may be considered to be semi-disposable item.

For items that are disposable, it is clear to the user that following use, the item is discarded. However, for reusable items, and especially semi-disposable reusable items, it may be difficult for the user to know when the cleaning article is not longer at optimum effectiveness and should be discarded.

### SUMMARY

The present disclosure relates to a color-changing wear indicator on an article for providing a visual indication of wear. In one embodiment the article is a cleaning article. In one embodiment, the article comprises a nonwoven web of fibers, a base coating comprising a first color dispersed in a first binder, covering the working surface and structurally secures the fibers together, and a surface coating comprising a second color, different than the first color, dispersed in a second binder, covering the base coating. The surface coating wears causing exposure of the first color to indicate wearing of the web.

In another embodiment, an article comprises a substrate having a working surface with a first color and a surface coating consisting essentially of a second color, different than the first color, dispersed in a water-insoluble binder. The surface coating covers the first color of the substrate and the surface coating wears causing exposure of the first color to indicate wearing of the substrate. The article may further include a base coating at least partially covering the working surface to impart the first color to the substrate.

In another embodiment, an article comprises a substrate comprising a working surface, a base coating comprising a first color dispersed in a first binder and a surface coating comprising a second color, different than the first color, dispersed in a second binder. The base coating covers the entire working surface and the surface coating covers the base coating. The surface coating wears causing exposure of the first color to indicate wearing of the web.

In another embodiment, a method of making an article comprises providing a plurality of fibers, arranging the fibers to form a web, applying a base coating to the web to structurally secure the fibers together and applying a surface coating over the base coating. The base coating comprises a first color dispersed in a first binder, and the surface coating comprises a second color, different than the first color, dispersed in a second binder.

In another embodiment, a method of making an article comprises providing a substrate having a working surface, applying a base coating over the entire working surface of the substrate wherein the base coating comprises a first color dispersed in a first binder, and applying a surface coating over the base coating, wherein the surface coating comprises a second color, different than the first color, dispersed in a second binder.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a perspective view of one embodiment of a cleaning article including a color-changing wear indicator;

FIG. 2 is a side view of the cleaning article of FIG. 1;

FIG. 3 is an exploded side view of the cleaning article of FIG. 1;

FIG. 4 is a color photograph of a used cleaning article of FIG. 1.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

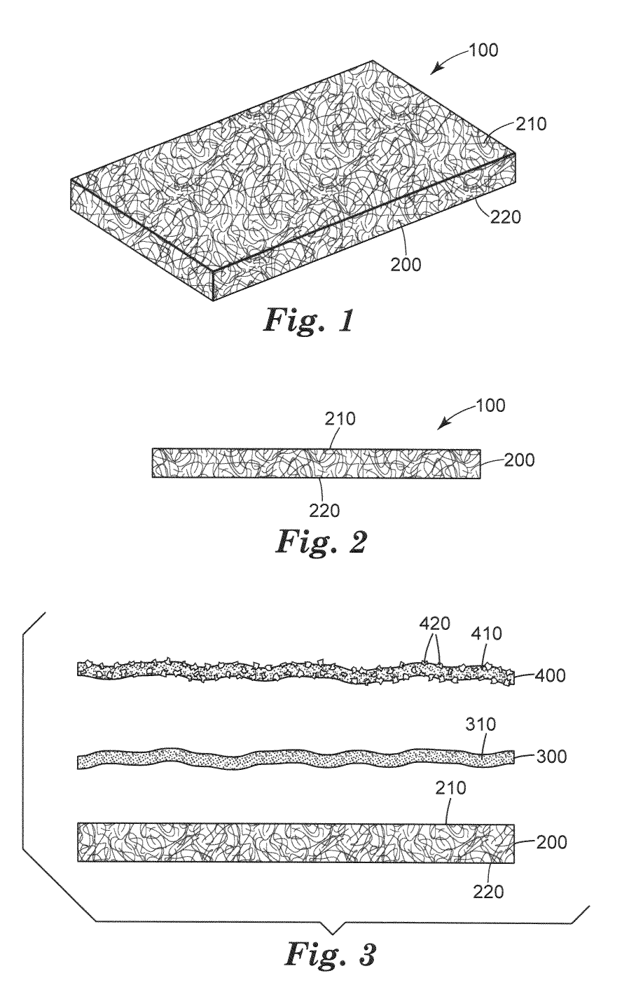

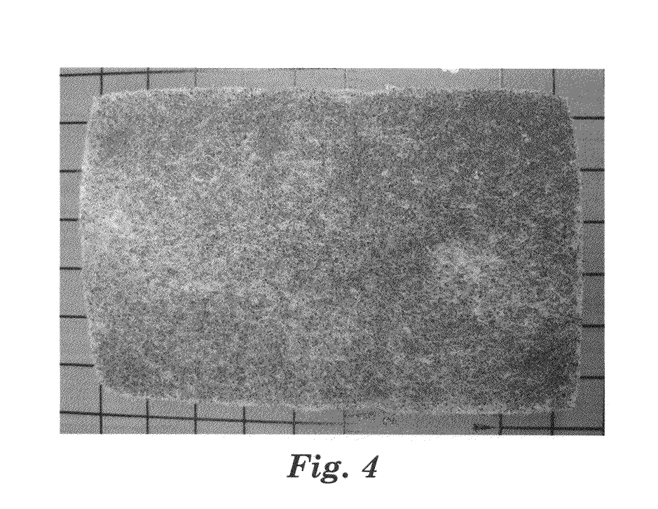

The present disclosure relates to an article comprising a color changing wear indicator. In one embodiment, the present disclosure relates to a cleaning article comprising a color changing wear indicator. FIGS. 1-4 show one embodiment of a cleaning article 100 including a color changing wear indicator. In particular, FIG. 1 is a perspective view, FIG. 2 is a side view, FIG. 3 is an exploded side view, and FIG. 4 is a photograph of the used cleaning article 100.

The cleaning article 100 comprises a substrate 200 with a base coating 300 and a surface coating 400, covering the base coating 300. In this embodiment, the substrate 200 is rectangular and includes a top surface 210 and a bottom surface 220, opposite the top surface 210. The top surface 210 and bottom surface 220 are generally planar. Generally, either or both the top surface 210 and bottom surface 220 are working surfaces that are intended to make contact with the surface to be cleaned. In this embodiment, there are two working surfaces (top surface 210 and bottom surface 220).

It is understood that any number of shapes and sizes of the substrate may be used for the cleaning article. For example, circular, triangle, or square surfaces may be provided. More than two working surfaces may be included. For example, if the substrate 200 has a cube shape, it may be that all six sides of the cube are working surfaces intended to contact the surface to be cleaned. In addition, although shown here the surfaces include a texture but as a whole are generally planar, it is not essential that the working surface be planar. The working surface may be textured, patterned, angled, concavely or convexly curved. The working surface may include raised regions and recessed regions.

The substrate 200 may be any known material used for wiping, cleaning, or scouring. Useful substrates include natural or synthetic sponges, pads formed of metal fibers such as steel wool pads or pads formed of narrow aluminum, bronze or plastic fibers or ribbons, knitted fabric, including three dimensional knitted spacers, woven fabric, and nonwoven fabric.

Nonwoven articles are particularly suitable as a substrate 200. A nonwoven article is a web of fibers bonded to one another. One exemplary nonwoven web that may be suitable as the substrate 200 of the cleaning article is the open, lofty, three-dimensional air-laid nonwoven substrate described in U.S. Pat. No. 2,958,593 to Hoover et al, the disclosure of which is herein incorporated by reference. This nonwoven web is formed by randomly disposed fibers. One commercial product comprising such a nonwoven web is that sold under the trade designation “Scotch-Brite” available from 3M Company, St. Paul, Minn.

Fibers suitable for use in cleaning articles include natural and synthetic fibers, and mixtures thereof. Synthetic fibers include those made of polyester (e.g., polyethylene terephthalate), nylon (e.g., hexamethylene adipamide, polycaprolactam), polypropylene, acrylic (formed from a polymer of acrylonitrile), rayon, cellulose acetate, polyvinylidene chloride-vinyl chloride copolymers, vinyl chloride-acrylonitrile copolymers, and so forth. Suitable natural fibers include those of cotton, wool, jute, and hemp. The fiber used may be virgin fibers or waste fibers reclaimed from garment cuttings, carpet manufacturing, fiber manufacturing, or textile processing, for example. The fiber material can be a homogenous fiber or a composite fiber, such as bicomponent fiber (e.g., a co-spun sheath-core fiber). It is also within the scope of the invention to provide an article comprising different fibers in different portions of the web (e.g., the first web portion, the second web portion and the middle web portion). The fibers of the web are preferably tensilized and crimped but may also be continuous filaments formed by an extrusion process such as that described in U.S. Pat. No. 4,227,350 to Fitzer, as well as the continuous fibers described in U.S. Pat. Nos. 4,991,362 and 5,025,596 to Heyer et al.

Metal fibers may also be used to make a nonwoven. In one embodiment, the metal fibers are blended with nonmetal fibers such a synthetic fibers. In particular, the metal fibers are blended with a bicomponent synthetic fiber. Suitable metals include, for example, steel, aluminum, copper, bronze, gold, platinum, titanium.

In one embodiment, fibers for use in the nonwoven web are between about 10 and about 110 millimeters and preferably between about 30 and about 65 millimeters in length and have a fineness or linear density ranging from about 1.5 to about 500 denier and preferably from about 8 to about 110 denier. It is contemplated that fibers of mixed denier can be used in the manufacture of a nonwoven web in order to obtain a desired surface finish. The use of larger fibers is also contemplated, and those skilled in the art will understand that the invention is not limited by the nature of the fibers employed or by their respective lengths, linear densities and the like.

Nonwoven webs suitable for use as the substrate 200 of the cleaning article 100 may be made by a variety of known processing techniques including carding, garneting, airlaying, spunbond, wet-laying, melt blowing, stitchbonding. Further processing of a nonwoven may be necessary to add properties such as strength, durability, and texture. Examples of further processing include calendering, hydroentangling, needletacking, resin bonding, thermobonding, ultrasonic welding, embossing, and laminating. Typically, when constructing a nonwoven web, following arrangement of the fibers, the fibers must be reinforced or secured, to form a structure that has structural integrity. A nonwoven web with structural integrity is capable of being handled with the fibers not readily disengaging from one another. The fibers can be reinforced or secured through mechanical mechanisms, such as needletacking or hydro-entangling, or through chemical mechanisms, such as bonding either through a binder and/or by heating meltable fibers to melt point and fuse to one another.

To chemically bind the fibers together, the web may be reinforced, for example, by the application of a prebond binder which typically is a resin to bond the fibers at their mutual contact points to form a three-dimensionally integrated structure as described in Hoover et al. In some constructions, an additional second binder is applied over the prebond binder to further reinforce the web. The selection and amount of binder actually applied can depend on any of a variety of factors including, for example, the fiber weight in the nonwoven web, the fiber density, the fiber type, as well as the contemplated end use for the finished article. Application of the binder can be accomplished by roll coating, spray coating, dry powder coating, suspended powder coating, powder dropping, liquid dip coating, fluidized bed powder coating, electrostatic powder coating, critical gas dilution liquid resin coating, or other commonly used coating processes.

Other known means of forming a three-dimensionally integrated structure from the nonwoven fibers are within the scope of the present invention. As an alternative or in addition to a prebond binder applied to the fibers to form the nonwoven, the fibers may be melt-bonded together at a portion of points where they contact one another to form a three-dimensionally integrated structure, as described in U.S. Pat. No. 5,685,935 to Heyer et al.

Useful nonwoven webs preferably have a weight per unit area at least about 20 g/m², preferably between 20 and 1000 g/m², more preferably between 300 and 600 g/m². The foregoing fiber weights typically will provide a web having a thickness from about 1 to about 200 millimeters, typically between 5 to 75 millimeters, and preferably between 5 and 25 millimeters.

The cleaning article 100 includes a color changing wear indicator. The color changing wear indicator comprises a surface coating 400 over the substrate, wherein the substrate 200 includes a first color to give the substrate 200 the appearance of the first color. The surface coating 400 comprises a binder, typically a water-insoluble binder, and a second color, different than the first color, to give the surface coating 400 the appearance of the second color. The second color is different than the first color of the substrate 200. The surface coating 400 is applied over the working surface of the substrate 200 to cover the first color of the substrate 200 so that initially the cleaning article 100 has the appearance of the second color of the surface coating 400. The surface coating 400 wears causing exposure of the first color to indicate wearing of the substrate 200. Upon seeing the first color, the user will know that the cleaning article is ready for replacement.

The wear may be caused by frictional forces between the substrate and the contacted surface. The wear may be caused by exposure to a solvent for a binder that is soluble in that particular solvent. In any case, the wear causes removal of the surface coating 400 from the substrate 200.

The substrate 200 may be colored or may separately include a material containing a color to impart the first color. For example, a colored fiber may be used to make a nonwoven web. In another embodiment, the substrate 200 may be coated with a base coating, which includes a color to give the substrate 200 the appearance of the first color. The embodiments shown in FIGS. 1-4 show a base coating 300 and a surface coating 400 on the substrate 200.

In the embodiment with the base coating 300, the base coating 300 is applied to all or a portion of the substrate 200. If applied to a portion of the substrate 200, the base coating 300 may be applied in a pattern or a graphic. The base coating 300 comprises a first color dispersed throughout a binder. Further, the color changing wear indicator comprises a surface coating 400 that comprises a second color, different that the first color, dispersed throughout a binder. The surface coating 400 is applied over the base coating 300 to cover the appearance of the first color of the base coating 300. Therefore, depending on the application of the base coating 300, the surface coating 400 may be applied to all or a portion of the substrate 200.

The binder incorporated in the base coating 300 and surface coating 400 may be the same binder or different binders may be utilized. The binder is any substance that will cohere to the substrate. Following curing, the binder may be water soluble or water insoluble. Generally, a water insoluble binder is one that does not lose more than 5% wt. of the total binder weight upon submersion in water. The solubility of the binder chosen will depend on the extent of uses the particular cleaning article will be able to undertake prior to a color changing appearance indicating the end of life of the cleaning article.

The binder may be a resin. Suitable resins include phenolic resins, polyurethane resins, polyureas, styrene-butadiene rubbers, nitrile rubbers, epoxies, acrylics, and polyisoprene. The binder may be water soluble. Examples of water soluble binders include water-soluble binders include surfactants, polyethylene glycol, polyvinylpyrrolidones, polylactic acid (PLA), polyvinylpyrrolidone/vinyl acetate copolymers, polyvinyl alcohols, carboxymethyl celluloses, hydroxypropyl cellulose starches, polyethylene oxides, polyacrylamides, polyacrylic acids, cellulose ether polymers, polyethyl oxazolines, esters of polyethylene oxide, esters of polyethylene oxide and polypropylene oxide copolymers, urethanes of polyethylene oxide, and urethanes of polyethylene oxide and polypropylene oxide copolymers.

In one embodiment, the binder cures to be generally clear or colorless. A binder that cures to be generally clear or colorless is more easily colored to a desired selected color. A binder that may have a color or cloudiness may be difficult to achieve a desired color. Examples of binders that cure to be generally colorless include styrene-butadiene rubbers, acrylics, and epoxies.

Including a water soluble binder or a blend of a water soluble binder and a water insoluble binder in the base coating, surface coating, or both may accelerate the time to a color change. Therefore, instead of simply wearing away, the base coating, surface coating, or both may also dissolve away with use. Depending on the number of uses or expected time exposed to water, one skilled in the art would be able to design the binder to tie to a useful life of the cleaning article. Typically, the binder of the surface coating includes at least a portion that is water insoluble, to slow the process of showing wear.

In one embodiment, various processing techniques may be applied to all or a portion of the binder in the base coating 300 (if included) or the surface coating 400 to enhance the resistance to wear. For example thermal curing, UV curing, or e-beam curing may be used with the appropriately selected resins. In this embodiment, uncured portions wear faster than cured portion.

The first color is dispersed throughout the binder of the base coating 300. The second color is dispersed throughout the binder of the surface coating 400. The second color is different than the first color. Because the surface coating 400 is applied over the base coating 300, initially the cleaning article 100 has the appearance of the second color of the surface coating 400. However, with use of the cleaning article 100, the surface coating 400 wears away, exposing the first color of the base coating 300, which is different that that of the surface coating 400. Therefore, a user is able to visually identify a change in color (see FIG. 4). The change in color indicates to the user wear of the cleaning article 100 and therefore decreased efficacy of the cleaning article 100. The change in color is an indication to the user to discard the cleaning article 100.

The color included within the binder may be a dye or a pigment in liquid, powder or paste form. As discussed, the first color and second color are different from one another. In one embodiment, the first color and second color have a significant contrast to one another so that a color change is visually apparent. In one embodiment, the first color within the base coating 300 is of a lighter tone such as, for example, white, yellow, pink, or tan, while the second color within the surface coating 400 is of a darker tone, relative to the first color, such as, for example, green, blue, brown, or red. In one embodiment, the first color is yellow and the second color is green. It is understood that when the color is applied to the binder the components and properties of the binder may impact the actual final color of the resin.

The base coating 300, the surface coating 400 or both may include optional additives. Dispersed throughout the binder of the coating or separately applied following application of the coating may be may be a crosslinker, filler, catalyst, fragrance, perfume, microcapsules, antibacterial agents, antimicrobial agents, antifungal agents, antifoaming agents, thickeners, fillers, or abrasives. In one embodiment, including filler such as titanium dioxide in the surface coating 400 aids in covering the color substrate, which may be the color of a base coating 300, if included.

An abrasive 420 may be particularly advantageous as the abrasive aids in the scouring ability of the cleaning article. The abrasive 420 may be included in the surface coating 400 or base coating 300, if included, or may be separately applied after application of the surface coating 400 or base coating 300, if included. The abrasive particles 420 used in the cleaning article 100 include all known abrasive materials as well as combinations and agglomerates of such materials. In applications where aggressive scouring or other end uses are not contemplated or desired, softer abrasive particles (e.g., those having a Mohs' hardness in the range between 1 and 7) can be used to provide the finished article with a mildly abrasive surface. Soft abrasives include, without limitation, inorganic materials such as flint, silica, pumice, and calcium carbonate as well as organic polymeric materials such as polyester, polyvinylchloride, methacrylate, methylmethacrylate, polycarbonate, and polystyrene as well as combinations of any of the foregoing materials.

Harder abrasive materials (e.g., having a Mohs' hardness greater than about 8) can also be included to provide a finished article having a more aggressive abrasive surface. Suitable hard abrasives include, without limitation, aluminum oxide including ceramic aluminum oxide, heat-treated aluminum oxide and white-fused aluminum oxide; as well as silicon carbide, alumina zirconia, diamond, ceria, cubic boron nitride, garnet, and combinations of the foregoing. Metal or glass particles or fibers may be used as the abrasive. A combination of hard and soft abrasive may be used. The average particle sizes of the foregoing abrasives can range from about 1 to about 2000 microns. In one embodiment, the visual appearance of a color change is tied to the wearing away of the abrasive included in the base coating, top coating, or both.

In one embodiment, the base coating 300 (prior to curing) includes from 50 to 90% wt. binder, more typically from 60 to 85% wt. binder and from 0.2 to 1.5% wt. color, more typically from 0.4 to 0.75% wt. color. In one embodiment, the surface coating 400 (prior to curing) includes from 10 to 30% wt. binder, more typically from 15 to 25% wt. binder and from 0.2 to 1.5% wt. color, more typically from 0.4 to 1.0% wt. color (which does not include fillers). If included, the surface coating 400 include from may include from 20 to 70% wt. abrasive. Particularly, if included the surface coating 400 may include from 40 to 60% wt. hard abrasive. As discussed above, additional components may be included in either the base coating 300 and/or surface coating 400.

The base coating 300, if included, may be applied to the substrate 200 by roll coating, spray coating, immersion coating, or other known coating techniques. The surface coating 400 may be applied over the base coating 300 by roll coating, spray coating, immersion coating, or other known coating techniques.

The selection and amount of the base coating and surface coating actually applied can depend on any of a variety of factors including, for example, the substrate type, if a nonwoven, the fiber weight in the nonwoven web, the fiber density, the fiber type, as well as the contemplated end use for the finished article. The coating weight of the base coating 300 may range from 50 to 300 gsm(dry), or from 100 to 200 gsm(dry). The coating weight of the surface coating 400 may range from 50 to 400 gsm(wet), or from 150 to 250 gsm(wet).

It is understood that the cleaning article may include the color changing indicator on one or more working surfaces. Further it is understood that the cleaning article may include additional cleaning layers such as one or more layers of sponge, foam, film, nonwoven, knitted fabric, woven fabric or various combinations thereof. For example, in one embodiment the cleaning article is a nonwoven web with the color changing indicator on one surface and attached to the opposite surface is a foam or sponge.

In one embodiment, the cleaning article includes a nonwoven substrate. For the color changing indicator, the base coating 300 having the first color is also the prebond binder that serves to reinforce the fibers of the web together. In other words, without the base coating 300 the nonwoven substrate does not have the structural integrity to maintain its shape through use and the base coating 300 is essential to holding the structure of the nonwoven together. The surface coating 400 having the second color is applied over the base coating 300. The surface coating 400 may also include an abrasive. One suitable method of making this embodiment, is to roll coat the base coating 300 over the fibers of the nonwoven and then to spray coat the surface coating 400. This embodiment is depicted in FIGS. 1-4. Specifically, with respect to FIG. 3, the substrate 100, base coating 300 and surface coating 400 are shown in a side exploded view. It is understood that the base coating 300 when applied over the web of fibers penetrates within the web to secure and reinforce the web creating a nonwoven article with structural integrity. Also, it is understood that the surface coating 400 when applied over the base coating 300 to cover the base coating 300. The surface coating 400 with also penetrate into the fibers of the web.

To make the cleaning article as previously discussed, the nonwoven can be prepared by first forming a web by using crimped staple fibers in a “Rando Webber” web-forming machine (available from Rando Machine Corporation, Macedon, N.Y.). The binder applied to the fibers the nonwoven web to facilitate bonding of the fibers at their mutual contact points is the base coating 300, which includes the first color. In one embodiment, the binder is roll coated onto the web. This coated web was then oven-dried to cure the binder of the base coating 300. Then, the web is spray coated with the surface coating 400, which includes the second color. This coated web is then oven-dried to cure the binder of the surface coating 400.

Incorporating the first color into the base coating 300 and the second color into the surface coating provides for an efficient manufacturing process as a binder coating is often necessary to secure the web of fibers together. Therefore, additional steps following web formation, such as further printing, which add cost to manufacturing, are not necessary.

In one embodiment, the cleaning article includes a substrate with the color changing indicator. The color changing indicator includes a substrate with a first color and a surface coating over the substrate consisting essentially of a second color and a water insoluble binder. To impart the first color to the substrate a base coating comprising a first color dispersed in a binder may be applied over the substrate prior to the surface coating. Then, the surface coating is applied over the base coating. Such a color changing indicator may be particularly suitable for cleaning articles that are not single use disposable articles but are intended to be used repeatedly over a period of time. Further, such a color changing indicator formulation becomes readily tied to the wear associated with the article itself. In this embodiment, the surface coating does not include a water soluble binder that dissolves away, but includes a water insoluble binder that wears away. Water insoluble binders include phenolic resins, polyurethane resins, polyureas, styrene-butadiene rubbers, nitrile rubbers, epoxies, acrylics, and polyisoprene.

In this embodiment, it is understood that additional components may be included the surface coating in addition to the second color and water insoluble binder so long as the components do not effect the solubility of the water insoluble binder. For example, abrasives, thickeners, perfumes, fragrance, antimicrobial agents, antifungal agents, antifoaming agents, or microcapsules may be included in the surface coating as these components do not affect the water solubility of the water insoluble binder.

To making one embodiment of the cleaning article, if a base coating 300 is included, the cleaning article is coated with the base coating 300 on to a substrate. Then, the surface coating 400 is coated over the base coating 300, to cover the base coating 300. As discussed above, the coating can be accomplished by a variety of known coating techniques. In one embodiment, the base coating also serves to bind the components, such as fibers, of the substrate together to achieve an article with structural integrity.

In one embodiment, the base coating covers the entire working surface of the substrate. It is understood that the wear of the surface coating may be random and discontinuous. In this embodiment, including the base coating over the entire working surface ensures that as areas of the surface coating wear, the color of the base coating will show through. In embodiments where the base coating is in discrete areas, zones or patterns, then wear of the surface coating may not reveal the color of the base coating, achieving the desirable color variation.

The cleaning article 100 is used to clean a surface. In it initial state the cleaning article has a first appearance. After repeated use, the surface coating 400 and the second color begin to wear away, exposing substrate and the first color. Therefore, the appearance of the first color of the substrate indicates to the user that the cleaning article should be discarded. One particularly suitable application for the cleaning article 100 is as a scouring article utilized in cleaning, scrubbing and scouring dishes, pots, and pans. Such a cleaning article is intended to be used in excess of 20 independent cleaning cycles. Also, such a cleaning article is utilized for its scouring function. The color changing indicator can be used to give an indication as to lessening scouring function of the cleaning article and in turn that the cleaning article should be discarded.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A article comprising:
a nonwoven web of fibers comprising a working surface;
a base coating comprising a first color dispersed in a first binder, wherein the base coating covers the working surface and structurally secures the fibers together;
a surface coating comprising a second color, different than the first color, dispersed in a second binder, wherein the surface coating covers the base coating;
wherein the surface coating wears causing exposure of the first color to indicate wearing of the web.

2. The article of claim 1, wherein the first binder and second binder are water-insoluble binders.

3. The article of claim 1, wherein the first binder cures to be colorless.

4. The article of claim 1, wherein the surface coating consists essentially of the second color, different than the first color, dispersed in the second binder and wherein the second binder is a water-insoluble binder.

5. The article of claim 1, wherein the base coating or surface coating further comprise an additive selected from the group consisting of abrasive particles, abrasive fibers, perfume, fragrance, thickener, fillers, crosslinker, catalyst, antifoaming agent, antimicrobial agent, antifungal agent, bactericide, microcapsules, or combinations thereof.

6. The article of claim 1, wherein the first color is of a lighter tone relative to the second color.

7. The article of claim 1, wherein the base coating entirely covers the working surface.

8. A article comprising:
substrate having a working surface with a first color;
a surface coating consisting essentially of a second color, different than the first color, dispersed in a water-insoluble binder, wherein the surface coating covers the first color of the substrate;
wherein the surface coating wears causing exposure of the first color to indicate wearing of the substrate.

9. The article of claim 8, further comprising a base coating at least partially covering the working surface to impart the first color to the substrate.

10. The article of claim 9, wherein the base coating covers the entire working surface.

11. The article of claim 8, wherein the first color is of a lighter tone relative to the second color.

12. The article of claim 8, wherein the substrate is selected from the group consisting of natural or synthetic sponges, pads formed of metal fibers, pads formed of a combination of metal and nonmetal fibers, knitted fabric, three dimensional knitted spacers, woven fabric, and nonwoven fabric.

13. A article comprising:
a substrate comprising a working surface;
a base coating comprising a first color dispersed in a first binder, wherein the base coating covers the entire working surface;
a surface coating comprising a second color, different than the first color, dispersed in a second binder, wherein the surface coating covers the base coating;
wherein the surface coating wears causing exposure of the first color to indicate wearing of the web.

14. A method of making an article comprising:
providing a plurality of fibers;
arranging the fibers to form a web;
applying a base coating to the web to structurally secure the fibers together, wherein the base coating comprises a first color dispersed in a first binder;
applying a surface coating over the base coating, wherein the surface coating comprises a second color, different than the first color, dispersed in a second binder.

15. The method of claim 14, wherein the base coating is applied over the entire working surface.

16. A method of making an article comprising:
providing a substrate having a working surface;
applying a base coating over the entire working surface of the substrate wherein the base coating comprises a first color dispersed in a first binder;
applying a surface coating over the base coating, wherein the surface coating comprises a second color, different than the first color, dispersed in a second binder.
